(19) United States
(12) Patent Application Publication
(10) Pub. No.: US 2024/0364593 A1
(43) Pub. Date: Oct. 31, 2024

(54) COMMUNICATION AMONG HIERARCHY OF MANAGEMENT SYSTEMS

(71) Applicant: Telefonaktiebolaget LM Ericsson (publ), Stockholm (SE)

(72) Inventors: Pedro Henrique GOMES DA SILVA, São Paulo (BR); Klaus RAIZER, Indaiatuba (BR); Mateus Augusto SILVA SANTOS, São Paulo (BR)

(21) Appl. No.: 18/681,719

(22) PCT Filed: Aug. 6, 2021
(86) PCT No.: PCT/EP2021/072068

§ 371 Date: Feb. 6, 2024

(51) Int. Cl. H04L 41/0894; H04L 41/16; H04W 8/22; H04W 24/08

(52) U.S. Cl. CPC H04L 41/0894; H04L 41/16; H04W 8/22; H04W 24/08

(57) ABSTRACT

A method performed by a network node for communicating information among a hierarchy of management systems structured as a plurality of layers including upper layers and a bottom layer for managing a communication network is provided. The method includes monitoring an update at the bottom layer after an action is executed in response to an intent specification received from an upper layer. The update includes information relating to whether the action was successfully fulfilled in the communication network. The method further includes determining a network capability of the bottom layer that corresponds to the executed action; updating an identification of network capability with the determined network capability of the bottom layer to obtain an updated identification of network capability; and propagating the updated identification of network capability to an upper layer above the bottom layer according to a defined policy.

### TECHNICAL FIELD

The present disclosure relates generally to communicating information among a hierarchy of management systems structured as a plurality of layers including upper layers and a bottom layer for managing a communication network, and related methods and apparatuses.

### BACKGROUND

Network operations may require an increase of autonomy of communication networks, which may mean that business, service, and network operations are able to decide and take the right actions based on dynamic goals and requirements of new services. Decision-making processes in autonomous communication networks (“autonomous networks”) ideally should take place without human intervention. In such a scenario, business objectives as well as expectations of customer and users are communicated to parts (e.g., software components, management domains, systems, components, etc.) of the autonomous network by means of “intents”.

Intents are machine-readable knowledge about goals, requirements, and constraints. Intents formally specify the expectations (including requirements, goals and constraints) that are given to a technical system. Intents objects are used for interactions between consumer devices (that wants the intent to be fulfilled) and producer devices (that should engage in fulfilling the intent). Intents are sent from consumer devices to producer devices and should be specified in terms of the consumer device's expectations and needs. Intents define what the consumer device is expecting to be achieved, but intents leave the details of how the expectation is achieved to a producer device of an intent-driven network. Intents typically are applied in a management system of an autonomous network in an approach referred to as intent-driven management. As used herein, the term “consumer device” is interchangeable with the terms “communication device”, “consumer”, “intent driven management service (IDMS) consumer”, and “management service (MnS) consumer”. As used herein, the term “producer device” is interchangeable with the terms “network node”, “producer”, “intent driven management service (IDMS) producer”, and management service (MnS) producer”.

FIG. 1 is a block diagram illustrating network management domains in an intent-driven management system and an example of a flow of intent objects. Referring to the example of FIG. 1, the flow of intent objects starts with business intents defined by human operators or customer-facing portals 112, 113 at the Business Support System (BSS) level (e.g., business operations 101), and is then followed by translation into intents (by intent handling function 110) that can be consumed by the Operations Support System (OSS) domain level (e.g., by OSS intent handling function 120 in service operation 103), and other types of intents that deal with services details. Further decomposing and/or derivation of intents can happen in intent handling functions 130, 140, 150, 160, 170 until the lowest level of management that supports intents, which in some cases can be the resources operations level 105.

At each layer of management (e.g., Business operations 101, Service Operation 103, Resource Operations 105), the intents are processed by an intent handling function(s) 110, 120, 130, 140, 150, 160, 170. The hierarchy of management layers produces sub-intents that are translated according to the management scope of each layer and, ultimately, actions are generated for execution by the network resources. Such actions typically may involve imperative procedures, using regular network management application interface (API) calls.

Examples of an intent-based management system is described in TM Forum by the autonomous networks project (see e.g., TM Forum, IG1230 Autonomous Networks Technical Architecture v1.0.0, 6 Nov. 2020, https://www.tmforum.org/resources/how-to-guide/ig1230-autonomous-networks-technical-architecture-v1-0-0/ (accessed 26 Jul. 2021) (referred to herein as “TM Forum”)), and in the Third Generation Partnership Project (3GPP) (see e.g., 3GPP TS 28.312 V0.4.0 (2021-03), Technical Specification Group Services and System Aspects; Management and orchestration; Intent driven management services for mobile networks (Release 17), https://www.3gpp.org/DynaReport/28312.htm (accessed on 26 Jul. 2021) (referred to herein as 3GPP 28,312 R17)). In 3GPP, management services are specified as intent-driven management services, where interactions between a management service consumer device and producer device may be simplified by applying intent objects that convey the management requests for service lifecycle management. In 3GPP terms, the entity that generates the intents is an intent-driven management service (MnS) consumer and the receiver of the intent is the intent-driven MnS producer. In a strictly hierarchical structure of intent handling functions (as illustrated in FIG. 1), the upper layer is usually the consumer and the lower layer is the producer.

As used herein, the terms “communication device”, “consumer”, and “intent driven management service (IDMS) consumer”, “management service (MnS) consumer” and “network node”, “producer”, “intent driven management service (IDMS) producer”, and “management service (MnS) producer” refer to the intent-driven management approach specified in 3GPP, and in a hierarchical management system. As such, unless otherwise stated, the terms “upper layer” or “upper management layer” refer to the consumer device, and the terms “lower layer” or “lower management layer” refer to the producer device. The terms “communication device”, “consumer”, “intent driven management service (IDMS) consumer”, and “management service (MnS) consumer” herein may be interchangeable and replace one another. The terms “network node”, “producer”, “intent driven management service (IDMS) producer”, and “management service (MnS) producer” may be interchangeable and replace one another.

Every intent, e.g. a list of consumer-defined expectations, typically is followed by an expectation fulfilment report that is sent by the IDMS producer to the IDMS consumer. An objective of the report is to keep the IDMS consumer informed about the status and fulfilment of its expectations. It is desirable that this cycle of intent generation, consumption, and reporting is continuous due to the dynamicity of communication network services requirements, and the network capabilities and resources availability that may change over time (e.g., of a fifth generation (5G) communication network).

As used, herein, the term “network capability” refers to resources and/or services (and their associated performance) that a communication network is currently able to deliver to successfully fulfill a given request originating from an IDMS consumer. A network capability can be, for example, a value that is assigned to a particular metric (e.g., link speed and time delay). A “feasible intent” can be specified in terms of a network capability, as discussed further herein.

Continuous feedback based on expectation fulfilment reports sent from a producer to a consumer is an important part of intent-based management. Since an IDMS producer is responsible for realizing the intents, there may be some gaps between the expected results from the consumer's perspective and the actual producer realization.

### SUMMARY

In an intent-driven management system, the intents express the requirements, constraints and goals from the consumer's perspective, and intent fulfilment is a collaborative process between the consumer and the producer that may involve reporting, escalations, judgement requests, etc. When intents are correctly interpreted and fulfilled, the number of interactions between the consumer and the producer are reduced. However, if the dynamicity of the services and/or of the network capabilities is high, such that most of the expectations in the intents cannot be, or cannot easily be, fulfilled and require escalations, judgements, and/or negative reporting, the number of interactions between the layers of a hierarchy of management systems structures as a plurality of layers can rapidly increase. Thus, some approaches for intent-driven management may include a large number of interactions during intent fulfillment; lack of service adaption to network capabilities; and lack of ability to learn network capabilities from experience.

Potential advantages provided by various embodiments of the present disclosure may include that by determining network capabilities of a bottom layer and propagating the network capability up to a communication device, the number of interactions during intent fulfillment may be reduced because the communication device can generate new intents or modify existing intents based on the known network capabilities. Further potential advantages may include that by adapting services to the network capabilities, complexity of management and the number of escalations due to service level agreement (SLA) breaches may be reduced. Another potential advantage may include that a machine learning (ML) model that translates successfully fulfilled intents into network capabilities can include learning network capabilities from experience. For example, a network node (i.e., a producer) may learn network capabilities from the experience of previously received intents and, thus, the network node does not need to be manually configured to advertise network capabilities.

In various embodiments, a method performed by a network node for communicating information among a hierarchy of management systems structured as a plurality of layers including upper layers and a bottom layer for managing a communication network is provided. The method includes monitoring an update at the bottom layer after an action is executed in response to an intent specification received from an upper layer. The update comprises information relating to whether the action was successfully fulfilled in the communication network. The method further includes determining a network capability of the bottom layer that corresponds to the executed action. The method further includes updating an identification of network capability with the determined network capability of the bottom layer to obtain an updated identification of network capability. The method further includes propagating the updated identification of network capability to an upper layer above the bottom layer according to a defined policy.

In some embodiments, the method further includes receiving the updated network capability at an upper layer from a lower layer beneath the upper layer. The method further includes determining a network capability of the upper layer that corresponds to the updated network capability received from the lower layer based on use of a second model. The method further includes updating an identification of network capability with the determined network capability of the upper layer to obtain an updated identification of network capability. The method further includes propagating the updated identification of network capability to another upper layer above the upper layer according to a defined policy.

In some embodiments, the information is a measurement of a degree of a fulfillment of the action, and the method further includes calculating a likelihood of successful execution of the action based on the update; and when the likelihood of successful execution is greater than a defined threshold, performing the determining.

In various embodiments, a network node for communicating information among a hierarchy of management systems structured as a plurality of layers including upper layers and a bottom layer for managing a communication network is provided. The network node includes processing circuitry, and at least one memory coupled with the processing circuitry. The memory includes instructions that when executed by the processing circuitry causes the network node to perform operations comprising monitor an update at the bottom layer after an action is executed in response to an intent specification received from an upper layer. The update comprises information relating to whether the action was successfully fulfilled in the communication network. The operations further include determine a network capability of the bottom layer that corresponds to the executed action. The operations further include update an identification of network capability with the determined network capability of the bottom layer to obtain an updated identification of network capability. The operations further include propagate the updated identification of network capability to an upper layer above the bottom layer according to a defined policy.

In various embodiments, a network node for communicating information among a hierarchy of management systems structured as a plurality of layers including upper layers and a bottom layer for managing a communication network is provided. The network node is adapted to perform operations comprising monitor an update at the bottom layer after an action is executed in response to an intent specification received from an upper layer. The update comprises information relating to whether the action was successfully fulfilled in the communication network. The operations further include determine a network capability of the bottom layer that corresponds to the executed action. The operations further include update an identification of network capability with the determined network capability of the bottom layer to obtain an updated identification of network capability. The operations further include propagate the updated identification of network capability to an upper layer above the bottom layer according to a defined policy.

In various embodiments, a computer program including program code to be executed by processing circuitry of a network node is provided. The program code causes the network node to perform operations comprising monitor an update at the bottom layer after an action is executed in response to an intent specification received from an upper layer. The update comprises information relating to whether the action was successfully fulfilled in the communication network. The operations further include determine a network capability of the bottom layer that corresponds to the executed action. The operations further include update an identification of network capability with the determined network capability of the bottom layer to obtain an updated identification of network capability. The operations further include propagate the updated identification of network capability to an upper layer above the bottom layer according to a defined policy.

In various embodiments, a computer program product including a non-transitory storage medium including program code to be executed by processing circuitry of a network node is provided. Execution of the program code causes the network node to perform operations comprising monitor an update at the bottom layer after an action is executed in response to an intent specification received from an upper layer. The update comprises information relating to whether the action was successfully fulfilled in the communication network. The operations further include determine a network capability of the bottom layer that corresponds to the executed action. The operations further include update an identification of network capability with the determined network capability of the bottom layer to obtain an updated identification of network capability. The operations further include propagate the updated identification of network capability to an upper layer above the bottom layer according to a defined policy.

In other embodiments, a method performed by a communication device in a communication network for managing an intent specification to a network node is provided. The method includes signalling an intent specification to the network node. The intent specification comprising an identification of at least one of a goal, a requirement, and a constraint that the communication device expects to be fulfilled in the communication network. The method further includes receiving a message from the network node including information relating to a network capability. The network capability corresponding to at least one of a resource, a service, and a performance of a service that the communication network can fulfill for the intent specification. The method further includes using the received network capability to (i) accept the network capability to fulfill the intent specification, or (ii) generate a new intent specification that has a greater probability of fulfillment by the communication network.

In some embodiments, the method further comprises signalling to the network node the (i) acceptance of the network capability to fulfill the intent specification, or (ii) the generated new intent specification.

In some embodiments, the information is a measurement of a degree of the fulfillment of the intent specification, and the method further comprises receiving from the network node measure of the likelihood of successful execution of the intent specification.

In various embodiments, a communication device in a communication network for managing an intent specification to a network node is provided. The communication device includes processing circuitry, and at least one memory coupled with the processing circuitry. The memory includes instructions that when executed by the processing circuitry causes the communication device to perform operations comprising signal an intent specification to the network node. The intent specification comprising an identification of at least one of a goal, a requirement, and a constraint that the communication device expects to be fulfilled in the communication network. The operations further include receive a message from the network node including information relating to a network capability. The network capability corresponding to at least one of a resource, a service, and a performance of a service that the communication network can fulfill for the intent specification. The operations further include use the received network capability to (i) accept the network capability to fulfill the intent specification, or (ii) generate a new intent specification that has a greater probability of fulfillment by the communication network.

In various embodiments, a communication device in a communication network for managing an intent specification to a network node is provided. The communication device adapted to perform operations comprising signal an intent specification to the network node. The intent specification comprising an identification of at least one of a goal, a requirement, and a constraint that the communication device expects to be fulfilled in the communication network. The operations further include receive a message from the network node including information relating to a network capability. The network capability corresponding to at least one of a resource, a service, and a performance of a service that the communication network can fulfill for the intent specification. The operations further include use the received network capability to (i) accept the network capability to fulfill the intent specification, or (ii) generate a new intent specification that has a greater probability of fulfillment by the communication network.

In various embodiments, a computer program including program code to be executed by processing circuitry of a communication device is provided. The program code causes the communication device to perform operations comprising signal an intent specification to the network node. The intent specification comprising an identification of at least one of a goal, a requirement, and a constraint that the communication device expects to be fulfilled in the communication network. The operations further include receive a message from the network node including information relating to a network capability. The network capability corresponding to at least one of a resource, a service, and a performance of a service that the communication network can fulfill for the intent specification. The operations further include use the received network capability to (i) accept the network capability to fulfill the intent specification, or (ii) generate a new intent specification that has a greater probability of fulfillment by the communication network.

In various embodiments, a computer program product including a non-transitory storage medium including program code to be executed by processing circuitry of a communication device is provided. Execution of the program code causes the communication device to perform operations comprising signal an intent specification to the network node. The intent specification comprising an identification of at least one of a goal, a requirement, and a constraint that the communication device expects to be fulfilled in the communication network. The operations further include receive a message from the network node including information relating to a network capability. The network capability corresponding to at least one of a resource, a service, and a performance of a service that the communication network can fulfill for the intent specification. The operations further include use the received network capability to (i) accept the network capability to fulfill the intent specification, or (ii) generate a new intent specification that has a greater probability of fulfillment by the communication network.

### BRIEF DESCRIPTION OF DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a block diagram illustrating network management domains in an intent-driven management system and an example of a flow of intent objects;

FIG. 2 is a diagram illustrating an example of layers of a hierarchy of management systems and intent flows between them;

FIG. 3A is a diagram illustrating an example of an intent handling function augmented with network capability information objects in accordance with some embodiments of the present disclosure;

FIG. 3B is a diagram illustrating a typical intent fulfillment flow;

FIG. 4 is a diagram illustrating models in accordance with some embodiments of the present disclosure;

FIG. 5 is a diagram illustrating a conversational video request from a communication device to an operation layer, in accordance with some embodiments of the present disclosure;

FIG. 6 is a diagram illustrating a NEtwork Slice Type (NEST) template request from operations layer i to operations layer j, in accordance with an example embodiment of the present disclosure;

FIGS. 7A-7C are an excerpt from 3GPP TS 23.501 V17.1.1;

FIG. 8 is a diagram illustrating actions sent from operations layer j to the resources, in accordance with an example embodiment of the present disclosure;

FIG. 9 is a sequence diagram illustrating operations of a bottom layer where updates follow actions, in accordance with some embodiments of the present disclosure;

FIG. 10 is a sequence diagram illustrating operations of other layers above the bottom layer, in accordance with some embodiments of the present disclosure;

FIG. 11 is a block diagram illustrating a communication device according to some embodiments of the present disclosure;

FIG. 12 is a block diagram illustrating a network node according to some embodiments of the present disclosure;

FIGS. 13-14 are flow charts illustrating operations of a network node according to some embodiments of the present disclosure;

FIGS. 15-16 are flow charts illustrating operations of a communication device according to some embodiments of the present disclosure;

FIG. 17 is a block diagram of a communication system in accordance with some embodiments of the present disclosure;

FIG. 18 is a block diagram of a communication device in accordance with some embodiments of the present disclosure;

FIG. 19 is a block diagram of a network node in accordance with some embodiments of the present disclosure; and

FIG. 20 is a block diagram of a virtualization environment in accordance with some embodiments of the present disclosure.

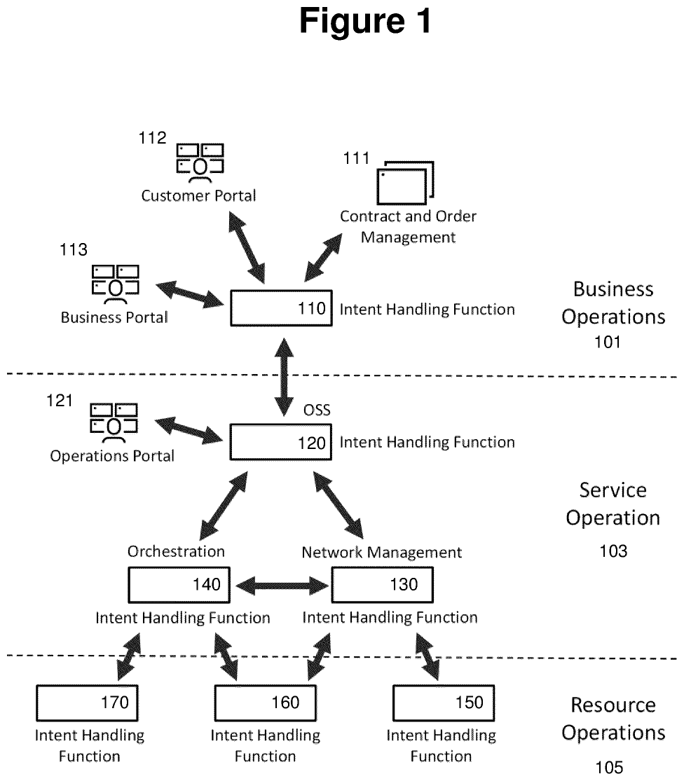

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

The following explanation of potential problems with some approaches is a present realization as part of the present disclosure and is not to be construed as previously known by others.

In an intent-driven management system, the intents express requirements, constraints, and goals from the consumer's perspective; and the intent fulfilment is a collaborative process that may involve reporting, escalations, judgement requests, etc.

Even though intent-driven management aims for simplicity from a consumer's point of view (since the consumer does not need to be concerned with the fine details of intent fulfilment), a side-effect is that the complexity is increased from the producer's point of view. The simplicity of intents may reduce the interactions between consumer and producer if the intents are correctly interpreted and fulfilled. However, if the dynamicity of the services and/or of the network capabilities is too high, such that most of the expectations in the intents cannot be, or cannot easily be, fulfilled and result in escalations, judgements, and/or negative reporting, the number of interactions between the layers can rapidly increase.

Considering that intents from higher layers may be decomposed into sub-intents that travel the management hierarchy until they reach the resources level, any issue or incapacity to fulfil the intents at lower layers (e.g., closer to the resources) may exponentially increase the number of interactions, because the escalation may need to be propagated all the way up to the intent origin at the business level.

As a consequence, in highly dynamic environments, either because of services requirements or network resources that change very frequently, there is a need to reduce the interactions in intent-based management. In some approaches, expectation fulfillment reports may be used by the consumer to dynamically change the intents when the intents are not completely fulfilled, or even escalate possible issues to upper layers that may be concerned with that given intent. In a hierarchical management system, an intent can be decomposed into sub-intents. Therefore, an expectation fulfillment report indicating that a sub-intent is not fulfilled may need to be translated into a report that indicates that the original intent is not fulfilled either. In some intent handling approaches proposed in the literature and standardization, a feedback loop created by expectation fulfillment reports sent by the IDMS producers towards the IDMS consumers and the intent lifecycle management from IDMS consumers to IDMS producers are relied on. See e.g., TM Forum, 3GPP TS 28.312 R17; and Intent-Based Networking—Concepts and definitions, Active Internet-Draft (22 Feb. 2021), https://datatracker.ietf.org/doc/draft-irtf-nmrg-ibn-concepts-definitions/ (accessed 26 Jul. 2021) (referred to herein as “IETF”). However, there is a gap in information from a bottom layer to an upper layer.

Various embodiments of the present disclosure can fill the gap of typical intent flows with an augmentation including producer centric information, which may improve the intent fulfilment process. A method is provided for real-time (or near real-time) bottom-up determination of network capabilities for intent-driven network automation. As used herein, “bottom-up” refers to propagation of determined network capabilities upwards from a bottom layer to an upper layer.

While network performance provides the actual measure of a current network state that shows the actual state of a network at a given time, the term “network capability” refers to resources and/or services (and their associated performance) that a network is currently able to deliver to successfully fulfill a given request originating from an IDMS consumer. Feasible intents allow, e.g., a service producer to inform a service consumer about intents having a higher likelihood of being fulfilled with less interactions. In various embodiments, these feasible intents can be used for solving a challenge of having an up-to-date list of possible intents that go beyond what is set by human operator, in other words, to know in real-time (or near real-time) the capabilities of a given network, even if new capabilities are integrated into the system or if current network capabilities change for any reason, e.g. resources overload, natural catastrophes, etc.

As used herein, the term “network capability” may be interchangeable and replaced with the term “feasible intent”. While the word “intent” is intrinsically consumer-centric, as used herein, a feasible intent (i.e., network capability) of the augmented information is producer-centric.

A network capability can be a value that is assigned to a particular metric (e.g., link speed and delay). A network capability represents a part of network states in a normal operation mode (e.g., with no overload that causes network issues).

The following table provides examples of network capabilities per layer of operation, where the layers of operation include (1) business operations expressed as service offerings that can be requested by a user through a front-end portal or an application interface (API); (2) service operations, which refer to service requirements to fulfill an incoming request from a business operations layer; and (3) resource operations, which refer to a set of network and computing resources that need to be allocated to instantiate and operate a service:

| Layer of operation | Examples of network capabilities |
|---|---|
| Business operation | conversational voice service, |
| | conversational video service, mission |
| | critical video service, real time gaming |
| | service |
| Service operation | performance metrics such as end-to-end |
| | latency, coverage area, maximum number |
| | of users |
| Resource operation | network path, network link, network node, |
| | compute node and associated capacities in |
| | terms of packet delay, packet error rate, |
| | data rate, bandwidth, processor clock |
| | speed, storage capacity |

In the method of various embodiments, an intent handling function of the network node receives an intent specification from a consumer (i.e., a communication device), produces an intent-driven management service, and reports on the intent fulfillment. A typical flow of intent objects can be augmented with another type of information object for dynamic propagation of up-to-date network capabilities from a producer to a consumer. Based on inclusion of the augmentation, the number of interactions between the management layers may be reduced including, e.g., in cases where intent fulfillment are more challenging. The method includes determining (e.g., generating) network capabilities based on learning intents that are successfully fulfilled by an IDMS producer (i.e., a network node).

In some embodiments, network capability generation is based on a machine learning (ML) model that translates intents generated and sent downwards by the intent handling function into a network capability that has high probability of successful fulfilment. The generated network capability is in a form that can be received upwards by the same intent handling function (e.g., expressed from the perspective of the communication device). The generated network capability generated is sent towards any relevant IDMS consumers and can be used in the future to generate intents having a higher probability of fulfilment. As a consequence, the number of interactions between the producer and consumer may be reduced. In some embodiments, the network capability can optionally be associated with a likelihood (e.g., a probability) of fulfilment.

Potential advantages provided by various embodiments of the present disclosure may include that, based on inclusion of an augmentation to a flow of intent objects to include a bottom-up determination and propagation of network capabilities, a consumer device (i.e., the intent originator) may consider a real-time, near real-time, and/or autonomous generated list of available network capabilities.

An additional potential advantage may be a reduction of the number of interactions between a consumer and a producer (i.e., between different management layers) during intent fulfillment because the network capabilities determined by the producer can be considered by the consumer for the generation of new or modified intents and the intent fulfilment may be more easily achieved. An intent expresses the consumer's expectations, and the intent may not be feasible in some cases. Even before the IDMS producer starts to fulfil the intent, there may be a need for intent negotiation to help ensure that the expectations are correctly interpreted by the IDMS producer. In both cases (intent fulfilment and intent negotiation), the interactions between producer and consumer may increase if the communication network's capabilities vary dynamically. Based on inclusion of network capabilities determined by the method of various embodiment, the determined network capabilities may be used to reduce the number of interactions because the IDMS consumer can generate new intents or modify the existing ones based on the determined network capabilities.

A further potential advantage may be service adaption to network dynamics. In programmable communication networks (e.g., future programmable networks), infrastructure resources and the possible services that can be offered may be highly dynamic, and new capabilities can be added or existing ones can be modified in the network (e.g. hardware added to the infrastructure, new virtualization platforms, network deterioration due to incidents, etc.). Based on inclusion of determined network capabilities in various embodiments, these new capabilities may be discovered by IDMS consumers so that the expectations on the services (i.e., intents) may be dynamically adapted. Adapting the services to the determined network capabilities may reduce the complexity of management and reduce the number of escalations due to SLA breaches.

Yet another potential advantage may include learning network capabilities from experience. In some approaches, it is challenging for an IDMS producer to learn network capabilities that are useful and/or needed by the IDMS consumers. In contrast, various embodiments of the present disclosure include learning this task over time from the experience of previously received intents. In some embodiments, a model is created with online or offline learning techniques (e.g., ML or artificial intelligence (AI) model/algorithm), and the model translates successfully fulfilled intents into network capabilities. Based on the learning, an IDMS producer does not need to be configured to advertise network capabilities set up by specialists, but rather the IDMS producer can learn the network capabilities based on the expectations that are received from the IDMS consumer. In some embodiments, the model is built on static rules-based and/or formula-based model, or a combination of an ML and/or AI model and a static rules-based or formula-based model. In some embodiments, an evolution from a rules-based static or formula-based model towards an AI/ML model happens with the increase in the autonomy level of the management systems.

Various embodiments of the present disclosure include a hierarchy of management systems structured as a plurality of different operations layers, including upper layers and a bottom layer for managing a communication network. In an example embodiments, the layers include a Business layer, a Service layer, a Resources layer, and a bottom layer with managed entities. The managed entities can include managed services and/or managed resources.

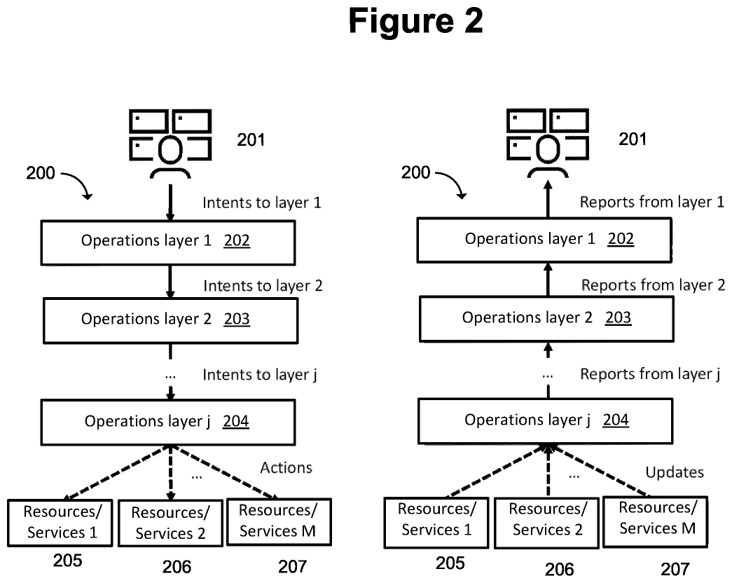

FIG. 2 is a diagram illustrating an example of layers of a hierarchy of management systems and intent flows between them. In the example of the left-side of FIG. 2, intents from a consumer (e.g., communication device 201) are received from upper layers 202 and 203 and they are broken down until actions are generated by upper layer 204 and sent towards the managed entities 205, 206, 207 (e.g., resources and services layer). As discussed herein, intent fulfilment is commonly followed by reports that are generated with status information about how the expectations are met, e.g. as illustrated in the example of the right-side of FIG. 2. The upper layers 202, 203, 204 (that is, Operations layers 1, 2 and j) are intent-aware and the interactions are based on the intent-report pattern. The bottom layer(s) (Resources/Services) 205, 206, 207 is not intent-aware and the interactions are based on Action-Update pattern. The actions can be any conventional API calls towards other functions that are not intent handling function, i.e. that are not intent-aware. Thus, all declarative expectations need to be translated into imperative actions and API calls to be processed by the bottom layer where resources are located.

In various embodiments of the present disclosure, the introduction of these new types of data (i.e., the network capabilities) does not break the main principle of intent-driven management, that is to allow a consumer-centric and simpler approach for management. The intents used in various embodiments still express the expectations from a consumer's perspective and can be freely set regardless of the network capabilities being advertised by service producer. The new information objects that represent “feasible intents” can be optionally used when intent-driven management becomes too complex due to the dynamics of service requirements or the dynamics of the network resources. For example, when the number of interaction for the intent fulfilment increase, such as when many management layers are included in the hierarchy of management systems.

A potential challenge when it comes to the process of generating network capabilities is that the IDMS producer may not be aware of the needs of the IDMS consumer and may advertise capabilities that are not required for the desired network service. Additionally, the network capabilities ideally should be expressed in a consumer-centric fashion, otherwise, if they are producer-centric, there is a need for a translation step before the advertised capabilities are used to create new intents from the consumer's perspective.

In some embodiments, a solution to this potential challenge is based on a learning process where the IDMS producer observes the intents that are successfully fulfilled and converts them from the bottom-up into higher-level “feasible intents” that can be used by any IDMS consumer and may have higher chances of also being successfully fulfilled. This conversion is executed based on a ML model that translates intents at a lower layer into intents at a higher layer. The ML model can be trained with data coming from the intents and the intents fulfillment reports. The conversion of various embodiments is the opposite of the typical intent conversion performed in a hierarchical management system, where typically high-level intents are translated/decomposed into low-level intents.

An intent handling function will now be further discussed.

In various embodiments, within each of the operations layers, the intents are processed by logical entities (referred to herein as “Intent Handling Functions” (IHF)). An IHF is the logical entity that performs the role of IDMS consumer and IDMS producers, respectively. The IHF that generates an intent performs the role of IDMS consumer because it will consume the intent-driven MnS produced by another IHF to send out the intent. This second IHF, which produces the intent-driven MnS performs the role of IDMS producer.

There can be one or more IHFs within each operations layer. Intents are exchanged between the IHFs. The IHFs operate by analyzing a discrepancy between an observed state of the network and a wanted state expressed by the intent. A task of the IHFs is to close this gap as much as possible.

When trying to close the gap between the current network state and the expected state, the IHF may derive new goals that it cannot fulfil alone and may start an engagement with neighboring IHFs that are operating within other operations layers or other management domains. In the example of FIG. 2, there are only intents sent downwards and upwards, but within each operations layer there may be other intents sent between neighboring IHFs that are specialized in specific aspects of the operations in that given management domain.

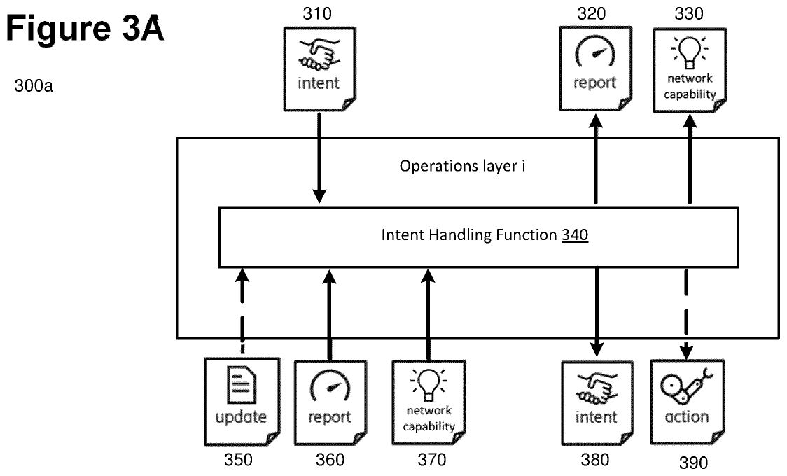

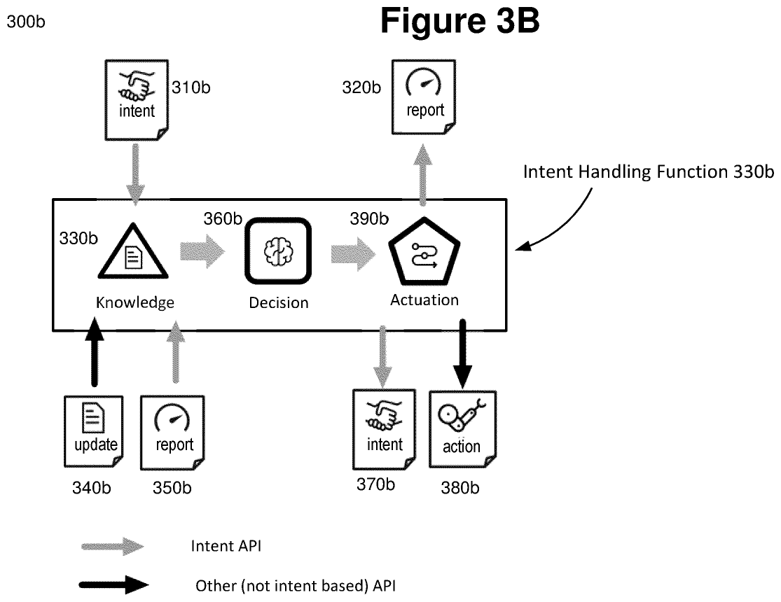

FIG. 3B is a diagram illustrating a typical intent fulfillment flow 300b. For all intents 310b received by an IHF 330b, it is expected to report 320b progress and status of the intent fulfilment back to the IHF that originated that intent.

In various embodiments of the present disclosure, the typical intent fulfillment flow is augmented with another type of information, i.e., with network capability. FIG. 3A is a diagram 300a illustrating an example of an IHF 340 of a network node augmented with network capability information objects 330, 370 in accordance with some embodiments of the present disclosure. Network capability information 330/370 is used to express intents that have a chance (e.g., a high chance) of being successfully fulfilled by the sending IHF 340. With this type of network capability information 330/370, current and/or future intents generated by a communication device may be more easily chosen to avoid further interactions; and/or such chosen intents may be raised by escalation due to lack of capabilities.

Intent translation models will now be discussed further.

Based on the layers included in a hierarchy of management systems, where the IHFs are responsible for processing and meeting expectations of intents, some embodiments of the present disclosure include a model trained to translate intents on the reverse direction (that is, bottom-up). While the description of these models considers only two operations layers for ease of discussion, the method includes a model(s) that scale to an arbitrary number of layers.

In some embodiments, each time an intent and/or an action is generated and sent from layer i to layer j, a set of updates Uₖ or reports Rⱼ are sent from bottom layers (e.g., layer j) to upper layers (e.g., layer i). An action(s) can be any conventional API call towards other functions that are not intent handling function, i.e. that are not intent-aware. Reports are responses to intents, while updates include any other type of data that is collected. For example, updates are responses to actions. Each report Rⱼ can be associated with an intent Iⱼ. Based on the downward intent Iⱼ, the most likely input intent I′ᵢ is predicted based on the model(s) trained at each layer.

The models can be stacked to derive possible or likely intents at all layers, starting with the actions, all the way up to the top layer.

For each layer, a model is trained that predicts the intents (e.g., most likely intents) that would be received from layers above, based on a given intent output sent to layers below, i.e.:

I′ᵢ=Mᵢ(Iⱼ)

Where I′ᵢ is the predicted intent input into operations layer i, Iⱼ is the intent output towards the bottom layer, and Mᵢ is the model that predicts l′ᵢ based on Iⱼ.

The bottom of the management stack includes a model that maps possible actions in the network (A) to intent input, i.e.:

I′ⱼ=Mₖ(Aₖ)

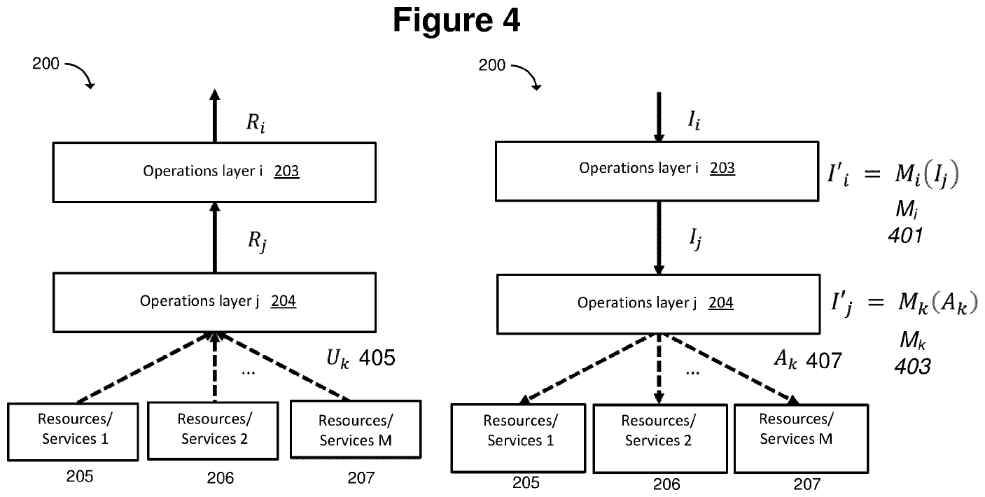

FIG. 4 is a diagram illustrating models in accordance with some embodiments of the present disclosure. The left-side of FIG. 4 illustrates an example of the updates and reports flow, and the right-side of FIG. 4 illustrates an example of the actions and intents flows.

Using such translation models, some embodiments of the present disclosure include consideration of the actions that resulted in positive reporting (e.g., successful actuation) to derive a list of “feasible intents”, that can be seen as network capabilities, and can be propagated up in the intent hierarchy. Such network capabilities can be used by upper layers to guide new intents being generated or to fine-tune the intents currently employed.

In an intent-driven management system, the decomposition of intents can be done in different ways, e.g., using simple rules or policies, or even with more sophisticated cognitive processes that can explore and/or exploit different decomposition schemes. Rules or policies can be used to hard-code the translation. For example, a rule can state: “Every intent that includes a NEST template should be translated into one single intent with a 5QI value”, because a NEST template has a feature where it can be expressed with which 5QI values are requested. In this example, a simple rule (or a policy) could be applied to translate right away. In some embodiments, other types of intents need more intelligence. For example, for an intent stating “minimize customer churn for the next 1 month” may be difficult to be translated by rules, etc.

Based on the way that an IHF executes the decomposition of intents from high layers to lower layers, models can be derived that translate an intent that is sent downwards into a likely intent that would be received by the intent handler upwards.

Models responsible for mapping bottom layers to top layers, e.g. Mⱼ or Mₖ, of some embodiments can be trained on datasets composed of past intent-based interaction between layers, as informed by the upward reporting mechanisms.

For example, if intents being fed into a first layer take the form:
   |1=[BusinessExpectation, conversationalService, [ConversationalService, conversationalVideoService1_users]]

As time progresses, a dataset can be recorded as illustrated in the following example:

l1_dataset = [
Sample 1 : [success = True, “BusinessExpectation”,
”http://conversationalServiceSlice_IRI”,
[“http://ConversationalService_IRI”, 100]],
Sample 2: [success = False, “BusinessExpectation”,
”http://another_conversationalServiceSlice_IRI”,
[“http://ConversationalService_IRI”, 90]],
...
]

In this example, the first column registers whether the intent was successfully achieved or not (i.e., “success=Ture” or “success=False” in this example), the second column is about the type of intent (i.e., “BusinessExpectation” in this example), the third column is a URL address pointing to a network resource (i.e., http://conversationalServiceSlice_IRI or http://another_conversationalServiceSlice_IRI in this example), and the fourth column is a vector of parameters (i.e., http://ConversationalService_IRI”, 100 or http://ConversationalService_IRI”, 90 in this example), and can contain strings, URLs, integers, etc.

In some embodiments, the model uses rule-based-systems, decision trees, and/or deep learning, graph neural networks, etc.

In some embodiments, given the graph structure of the knowledge available in the example data set above, and the dynamicity of features, the model is a graph neural network (GNN).

In some embodiments, the model is a ML or AI model when appropriate data representation is provided. For example, when “Sample 1” above is represented either as a linearized vector or as a graph. After training such a model as discussed herein, the model is used to estimate possibilities based on arbitrary inputs over a period of time. Examples of ML/AI models include, without limitation reinforcement learning using a reward coming from the updates and reports.

In some embodiments, for each operations layer, where an IHF is present, there is a model (discussed further herein), as follows:

I′ᵢ=Mᵢ(Iⱼ)

In some embodiments, reporting on intent fulfilment is done by all IHFs. The originator of the intents (that is, from a higher layer) keeps track of reports provided by the receiver of the intents (that is, a lower layer) and checks over time what intents are successfully fulfilled. The successful fulfilment of intents generates what is referred to herein as positive and/or successful reports.

In some embodiments, an IHF keeps track of all the positive reporting. If a report is successful, this means that the intent that generated that report can be fulfilled by the current network capabilities. This information (that a given intent can be successfully fulfilled) can be propagated not only to the originator of such intent but to any other IHF at upper layers that may be interested in using such network capability.

In some embodiments, the network capability is propagated considering a level of details and semantics that is understandable by the receiving IHF (i.e.,, at the upper layer). Therefore, in some embodiments, the intent is translated from a lower layer into higher layer using the models described herein.

Considering the stack of intent-driven management layers, the bottom layer is where the updates more closely represent the actual and up-to-date network capabilities. Thus, in various embodiments, propagation of network capabilities starts from the bottom layer, based on the updates received after actions are sent to managed entities (resources and/or services).

The method of various embodiments is discussed further below with reference to an example of an application of the method. The following discussion focuses first on the translation from imperative actions and commands to network capabilities (“feasible intents”); and then focuses in a second discussion on the translation of intents from one layer to another. The second discussion includes operations that are used by all operations layers above the resources/services layer, where translations between layers have to be based on intents, instead of actions.

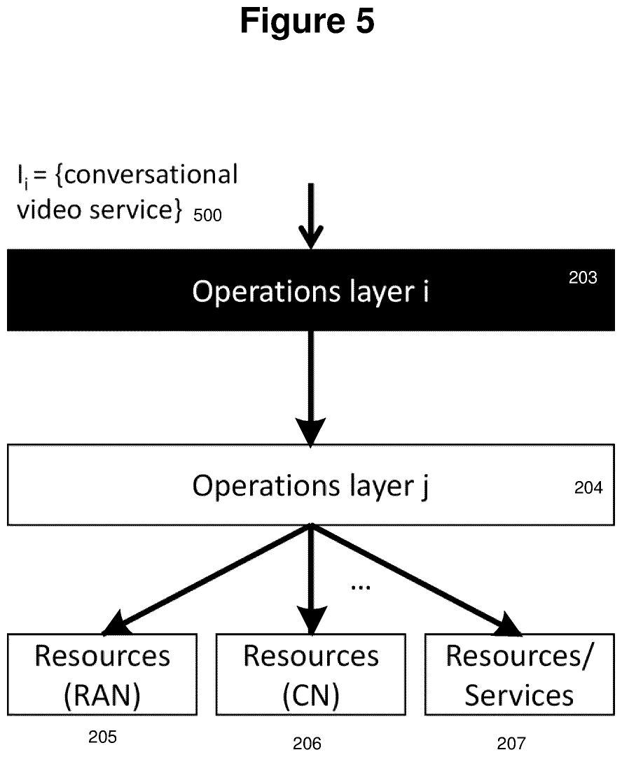

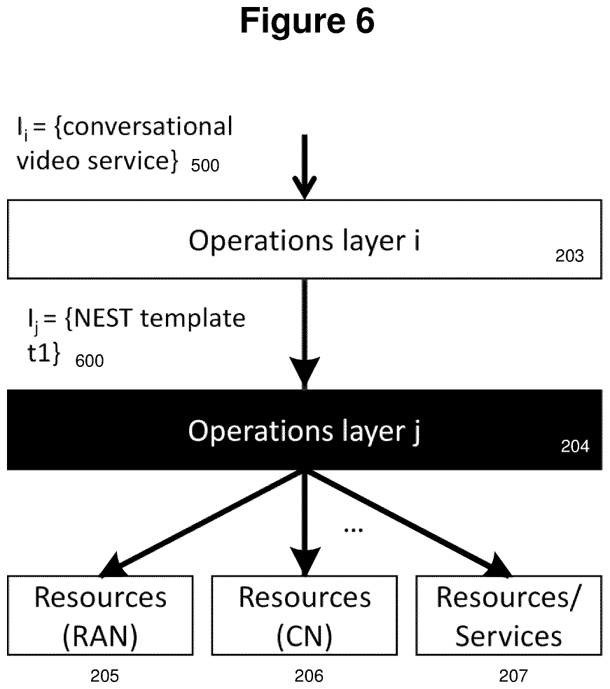

In the example application of the method, there is a problem of a large number of interactions between layers of a hierarchy of management systems that is tackled. FIG. 5 is a diagram illustrating a conversational video request from a communication device to an operation layer, in accordance with some embodiments of the present disclosure. The example starts with a communication device requesting a conversational video service that is expressed as an intent Iᵢ 500 sent to operations layer i 203. FIG. 6 is a diagram illustrating a NEtwork Slice Type (NEST) template t1 request from operations layer i 203 to operations layer j 204, in accordance with this example embodiment. As illustrated in FIG. 6, operations layer i 203 has its own context and decides to generate, based on the intent Iᵢ 500, another intent Iⱼ, 600 that specifies the new expectations as a NEST template to be deployed in the communication network for that conversational video service.

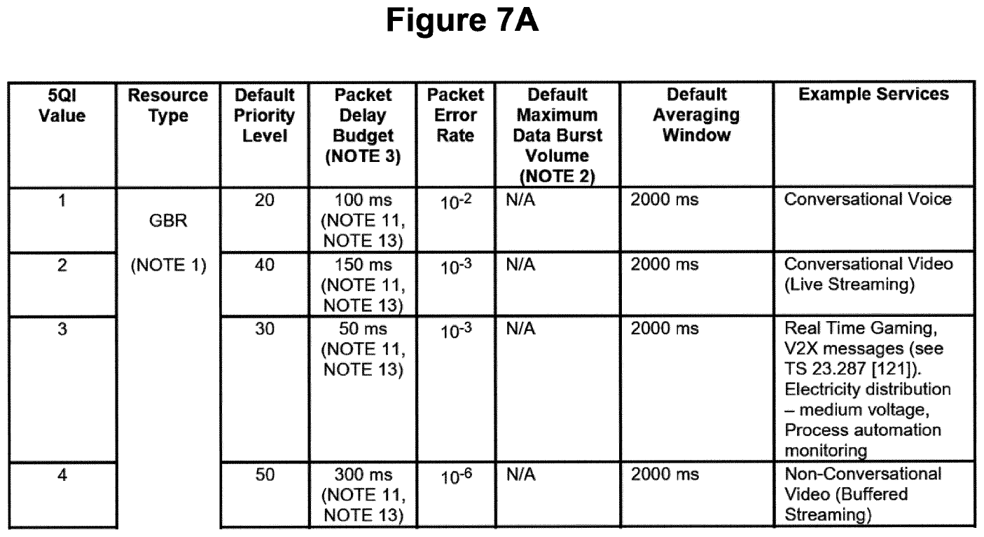

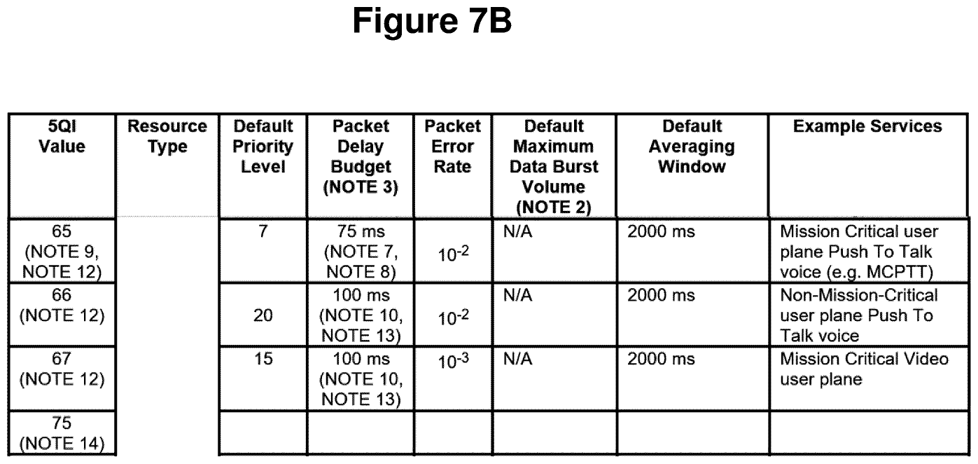

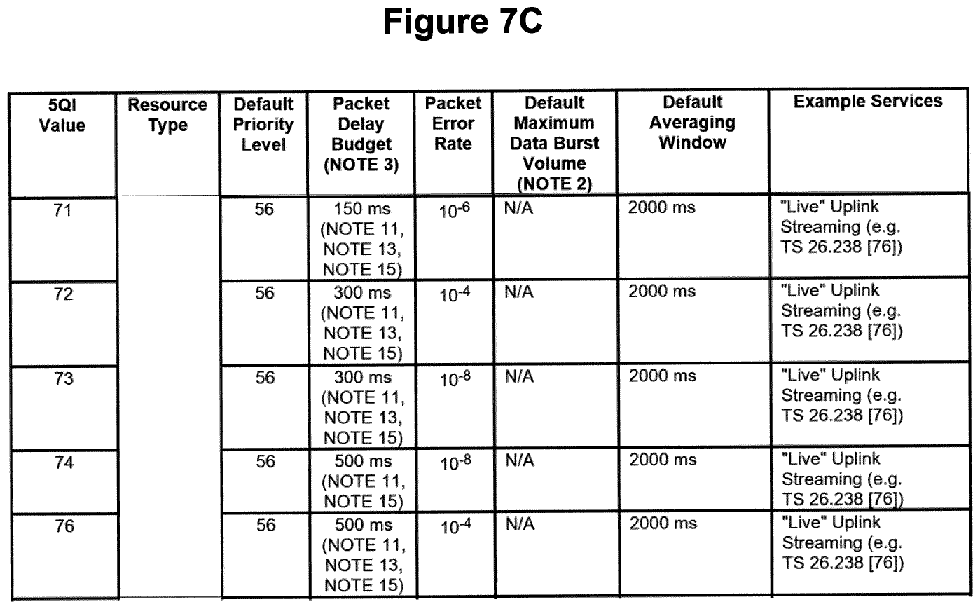

Operations layer j 204 has its own context and knowledge, which may include certain specifications, to realize the received intents. In this example, specification 3GPP TS 23.501 V17.1.1 is used, where standardized requirements for different services are specified. An excerpt from 3GPP TS 23.501 V17.1.1 is illustrated in FIGS. 7A-7C, including a fifth generation (5G) quality of service identifiers (“5QI”) values for example services. As shown in FIG. 7A, a conversation video (live streaming) service has a 5QI value of 2.

Based on the NEST template t1 request received, the operations layer j 204 decides which 5QI value it needs to request to be realized by the lower layers. For conversational video, operations layer j 204 decides to use 5QI equals to 2.

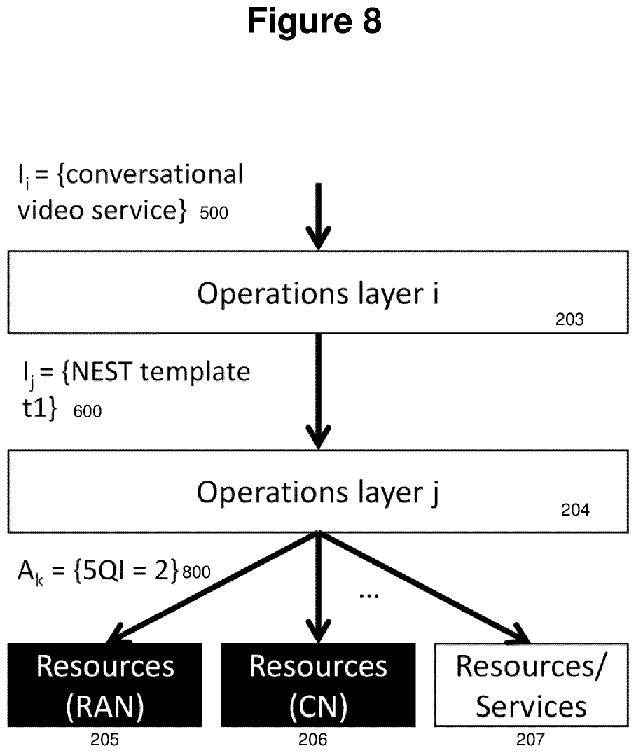

FIG. 8 is a diagram illustrating actions sent from operations layer j 204 to the resources, in accordance with this example embodiment. Since operations layer j 204 has direct access to the resources in different domains 205, 206, 207, operation layer j 204 can send an action 800 to configure the 5QI of resources in the communication network (a radio access network (RAN) in this example) and a network node (a core network node of the RAN in this example) to be equal to 2, as shown in FIG. 7A.

In one scenario of this example embodiments, resources layer 206 sends an update saying that 5QI could be set to 2, and as a consequence all requirements will be met, i.e. packet delay budget will be lower than 150 ms and packet error rate will be lower than 10⁻³ (as illustrated in the row of FIG. 7A corresponding to a 5QI value of 2).

In another scenario of this example embodiment, the resources cannot guarantee the packet error rate for 5QI equals to 2, and an update is sent telling the operations layer j 204 that the action requested, i.e., set 5QI equals to 2, could not be fulfilled. This means that the NEST template t1 requested was not fulfilled, so operations layer j 204 also sends a report to operations layer i 203 informing operations layer I 203 that the NEST template t1 requested was not fulfilled.

Responsive to the report to operations layer i 203, operations layer i 203 could issue another NEST template request that allows other values for 5QI. However, there could be an issue because if operations layer i 203 did so, neither operations layer j 204 nor operations layer i 203 know that the capabilities of resources layer 206 were constrained only in relation to packet error rate, but not for the packet delay budget. Thus, another 5QI value could be chosen, e.g. 5QI equals to 4, which has a less restrictive packet delay budget, but an even harder requirement on the packet error rate. As a result, if 5QI equals to 4 were chosen, another escalation (e.g., updates and reports indicating failed actions and intents fulfilment) will be followed, since the resources layer 206 is not yet able to fulfill 5QI equals to 4.

In the example embodiment, a solution to this issue is included. Resources layer 206 informs the upper layers about its known capabilities, which were learned from past experiences and are translated following the models discussed herein. The exact capability to be sent is also learned based on the previous requests received. In this example, it is clear that resources layer 206 needs to inform about its limited packet error rate capability. Hence, resources layer 206 sends a network capability: N_{c}={max packet error rate=10⁻²} to operations layer j 204.

Responsive to the resources layer 206 sending the network capability N_{c}, operations layer j 204 or operations layer i 203 determines that a feasible solution for the issue is to request 5QI equals to 66, since for this value the requirement on the packet error rate is equal to 10⁻² and the requirement on the packet delay budget is equal to 100 ms (see FIG. 7B), which is even lower than the initial requirement for 5QI equal to 2 (150 ms) and may be beneficial for the conversational video application.

Thus, in this example embodiment, the number of interactions for the intent negotiation can be reduced drastically as a result of use of the method of some embodiments of the present disclosure.

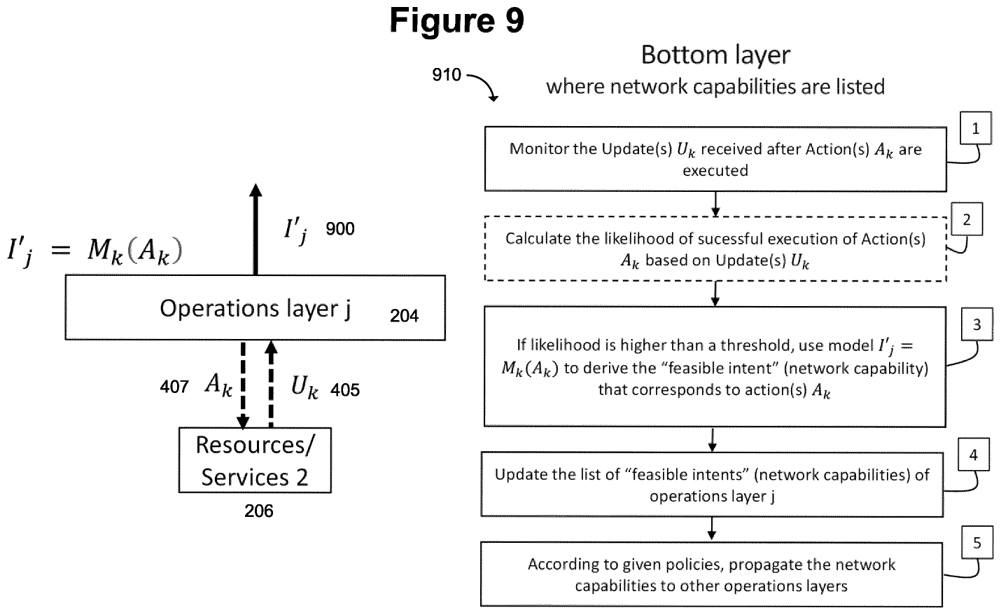

FIG. 9 is a sequence diagram 910 illustrating operations of a bottom layer 206 (illustrated to the left of the sequence diagram 910) where updates follow actions, in accordance with some embodiments of the present disclosure. In operation 1, resources layer 206 monitors updates Uₖ 405 received after an action(s) Aₖ 407 are executed. In the example of application of the method discussed herein, the updates include both “5QI equals to 2 was successfully fulfilled” or “5QI equals to 2 was not successfully fulfilled”.

In some embodiments, the method includes filtering and only the positive/successful reports are considered. In some embodiments, an update is not only a binary indication (e.g., successful/not successful), but rather is some measurement of a fulfillment level (e.g., delay is currently 10 ms, while the expectation was 9 ms). In some embodiments, when a measurement of a fulfillment level is included, an optional operation 2 is included where a likelihood of successful execution of the actions is calculated.

In some embodiments, the monitoring process of operation 1 is continuous and can only consider regular actions and/or reports that result from actual services instances running in the network. Alternatively, in some embodiments, some simulation or sandboxing is used to probe a set of hypothetical actions and proactively map the current network capabilities. In such embodiments, the actions are not received by a real network.

In operation 2, resource layer 206 can optionally calculate a likelihood of successful execution of action(s) Aₖ 407 based on updates Uₖ 405. In operation 3, operations layer j 204 uses model I′ⱼ=Mₖ(Aₖ) to derive a network capability that corresponds to action(s) Aₖ 407. As discussed herein, models are functions that translate the network capabilities (e.g., from X to Y) and they can be executed based on policies (discussed further below).

When the optional operation 2 is performed, operation 3 includes that if the likelihood of successful execution is higher than a defined threshold, bottom layer 206 uses model I′ⱼ=Mₖ(Aₖ) to derive a network capability that corresponds to action(s) Aₖ 407 that resulted in the received updates 405. In the example of application of the method discussed herein, after receiving an update “5QI equals to 2 was successfully fulfilled”, bottom layer derives a network capability “NEST template t1”, which indicates that the resources layer 206 is able to fulfill the NEST template t1. It is noted that the determined network capability is not necessarily the same as the received intent; if 5QI equals to 2 was also part of the NEST templates, the network capability can be a set of templates that the resources layer 206 is capable of fulfilling.

In operation 4, resource layer 206 updates a list of network capabilities of bottom layer 206.

In operation 5, according to a given policy (or policies), bottom layer 206 propagates the network capabilities upward to operation layer j 204, which is received by an IHF of layer 204. As discussed here, a policy includes a rule(s) (e.g., an ECA policy (Event, Condition, Action)) that govern the decision for when to propagate the network capabilities that were determined. For example, it may not be desirable to send network capabilities for every new network capability received from below. Thus, examples of policies include a simple rule that states that every 1 minute all the network capabilities are propagated; or that only for a set of users or services, the propagation will take place; etc.

Thus, the method of some embodiments can be used to pro-actively inform other intent handling functions about network capabilities from different layers.

At bottom layer 206, the model maps the actions into network capabilities, as discussed herein.

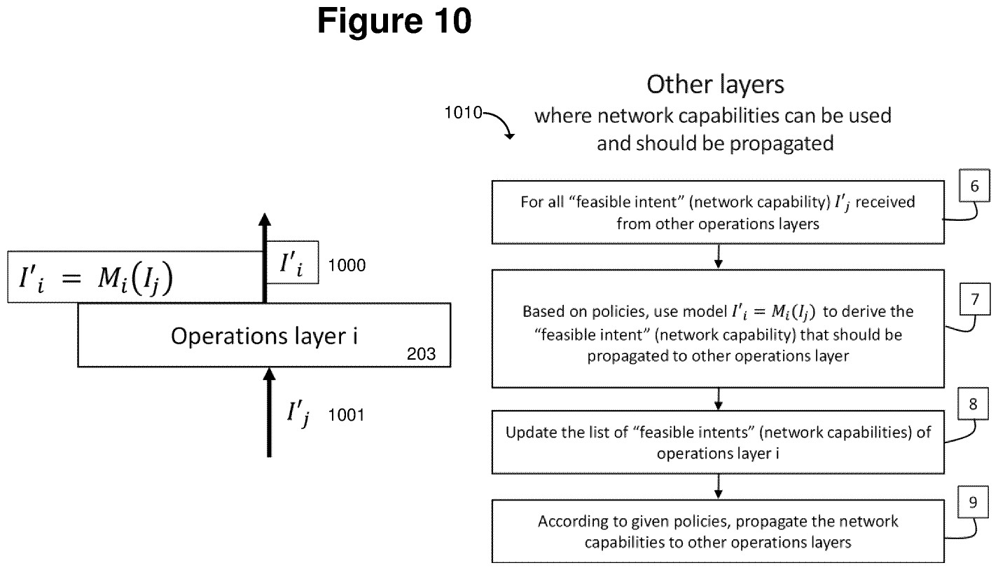

FIG. 10 is a sequence diagram illustrating 1010 illustrating operations of other layers (e.g., operations layer i 203 illustrated to the left of the sequence diagram 1010) above the bottom layer 206, in accordance with some embodiments of the present disclosure. As illustrated in FIG. 10, operations 6-9 are similar to operations 1, and 3-5 of FIG. 9 except for the model that maps intents between two adjacent layers. In some embodiments, the layers above the layer that has direct access to the managed resources do not have access to API calls that result in actions, therefore, these upper layers work mainly on an abstraction based on intent. In some embodiments, however, the intent handler present at any layer employs simultaneously intent-based as well as non-intent-based APIs (e.g., as shown in FIG. 3A).

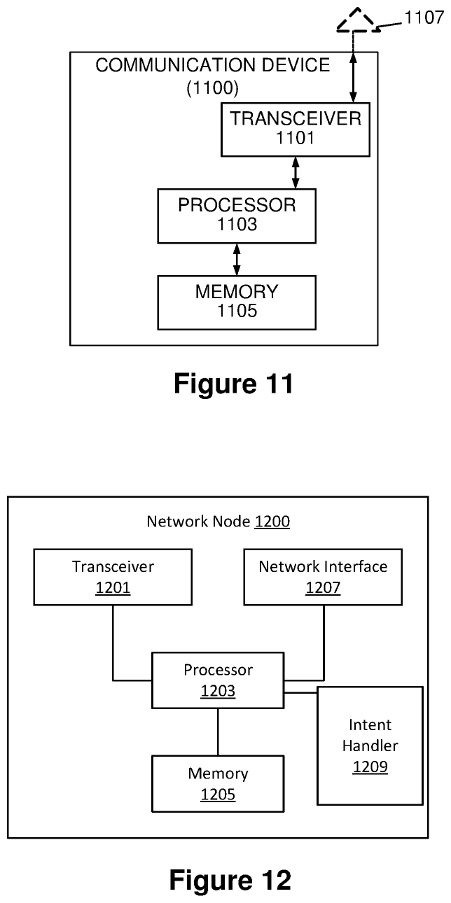

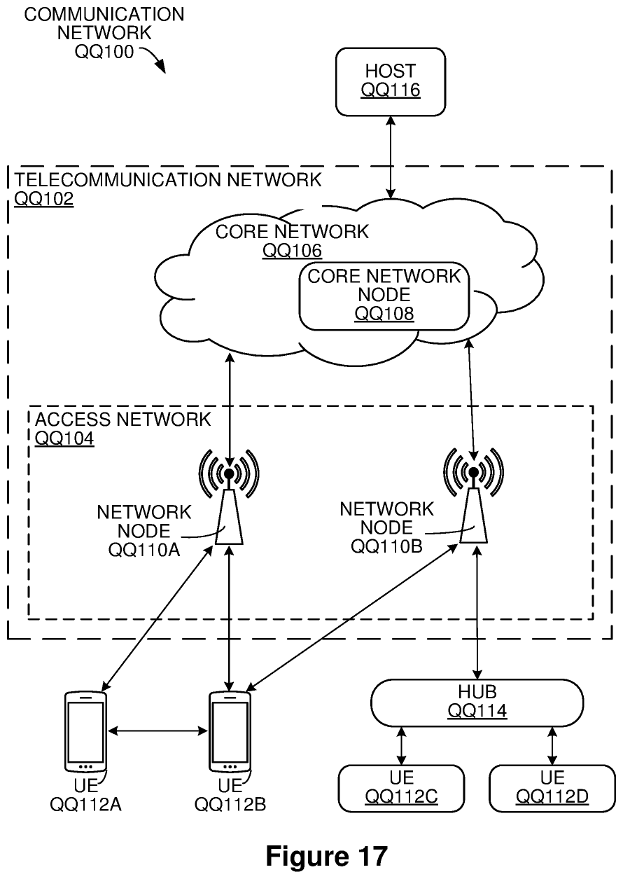

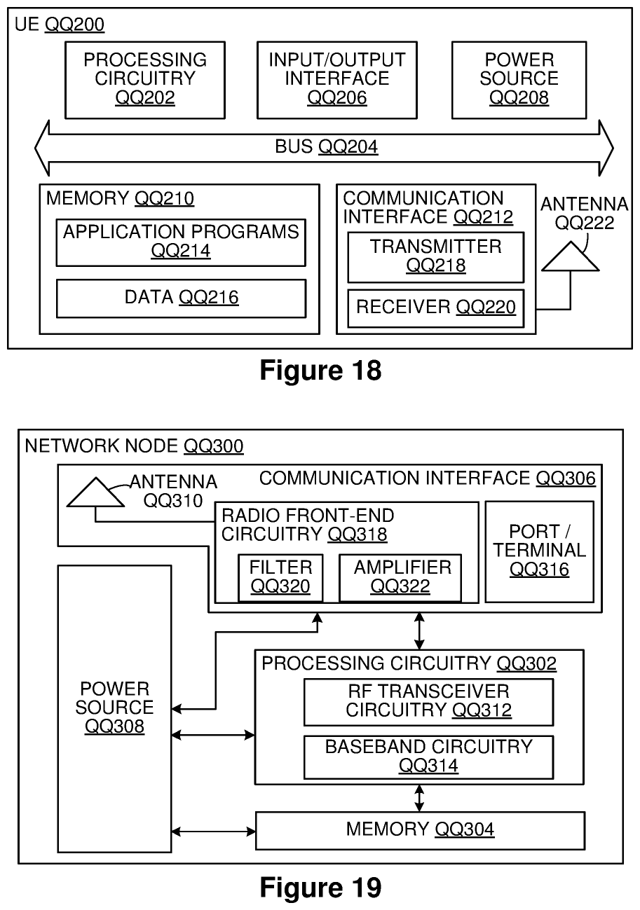

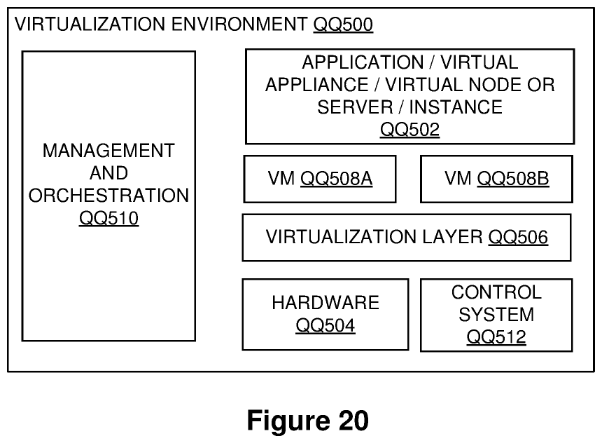

FIG. 11 is a block diagram illustrating elements of a communication device 1100 (also referred to as a mobile terminal, a mobile communication terminal, a wireless device, a wireless communication device, a wireless terminal, mobile device, a wireless communication terminal, user equipment, UE, a user equipment node/terminal/device, etc.) configured to provide wireless communication according to embodiments of inventive concepts. (Communication device 1100 may be provided, for example, as discussed below with respect to wireless devices UE QQ112A, UE QQ112B, and wired or wireless devices UE QQ112C, UE QQ112D of FIG. 17, UE QQ200 of FIG. 18, and virtualization hardware QQ504 and virtual machines QQ508A, QQ508B of FIG. 20, all of which should be considered interchangeable in the examples and embodiments described herein and be within the intended scope of this disclosure, unless otherwise noted.) As shown, communication device may include an antenna 1107 (e.g., corresponding to antenna QQ222 of FIG. 18), and transceiver circuitry 1101 (also referred to as a transceiver, e.g., corresponding to interface QQ212 of FIG. 18 having transmitter QQ218 and receiver QQ220) including a transmitter and a receiver configured to provide uplink and downlink radio communications with a base station(s) (e.g., corresponding to network node QQ110A, QQ110B of FIG. 17, and network node QQ300 of FIG. 19) of a radio access network. Communication device may also include processing circuitry 1103 (also referred to as a processor, e.g., corresponding to processing circuitry QQ202 of FIG. 18, and control system QQ512 of FIG. 20) coupled to the transceiver circuitry, and memory circuitry 1105 (also referred to as memory, e.g., corresponding to memory QQ210 of FIG. 17) coupled to the processing circuitry. The memory circuitry 1105 may include computer readable program code that when executed by the processing circuitry 1103 causes the processing circuitry to perform operations according to embodiments disclosed herein. According to other embodiments, processing circuitry 1103 may be defined to include memory so that separate memory circuitry is not required. Communication device may also include an interface (such as a user interface) coupled with processing circuitry 1103, and/or communication device UE may be incorporated in a vehicle.

As discussed herein, operations of communication device may be performed by processing circuitry 1103 and/or transceiver circuitry 1101. For example, processing circuitry 1103 may control transceiver circuitry 1101 to transmit communications through transceiver circuitry 1101 over a radio interface to a radio access network node (also referred to as a base station) and/or to receive communications through transceiver circuitry 1101 from a RAN node over a radio interface. Moreover, modules may be stored in memory circuitry 1105, and these modules may provide instructions so that when instructions of a module are executed by processing circuitry 1103, processing circuitry 1103 performs respective operations (e.g., operations discussed below with respect to Example Embodiments relating to wireless communication devices). According to some embodiments, a communication device 1100 and/or an element(s)/function(s) thereof may be embodied as a virtual node/nodes and/or a virtual machine/machines.

FIG. 12 is a block diagram illustrating elements of a network node 1200 (also referred to as an IHF, etc.) of a communication network (e.g., a Radio Access Network (RAN)) configured to provide communication according to embodiments of inventive concepts. (Network node 1200 may be provided, for example, as discussed below with respect to network node QQ110A, QQ110B of FIG. 17, network node QQ300 of FIG. 19, and/or hardware QQ504 or virtual machine QQ508A, QQ508B of FIG. 20, all of which should be considered interchangeable in the examples and embodiments described herein and be within the intended scope of this disclosure, unless otherwise noted.) As shown, the network node may include transceiver circuitry 1201 (also referred to as a transceiver, e.g., corresponding to portions of RF transceiver circuitry QQ312 and radio front end circuitry QQ318 of FIG. 19) including a transmitter and a receiver configured to provide uplink and downlink radio communications with mobile terminals. The network node may include network interface circuitry 1207 (also referred to as a network interface, e.g., corresponding to portions of communication interface QQ306 of FIG. 19) configured to provide communications with other nodes (e.g., with other network nodes) of the communication network. The network node may also include processing circuitry 1203 (also referred to as a processor, e.g., corresponding to processing circuitry QQ302 of FIG. 19) coupled to the transceiver circuitry, and memory circuitry 1205 (also referred to as memory, e.g., corresponding to memory QQ304 of FIG. 19) coupled to the processing circuitry. The memory circuitry 1205 may include computer readable program code that when executed by the processing circuitry 1203 causes the processing circuitry to perform operations according to embodiments disclosed herein. According to other embodiments, processing circuitry 1203 may be defined to include memory so that a separate memory circuitry is not required. The network node may also include a logical entity (ies) that handles intent(s) 1209 (e.g., referred to as an “intent handler” for ease of discussion in the present disclosure), as discussed herein.

As discussed herein, operations of the network node may be performed by intent handler 1209, processing circuitry 1203, network interface 1207, and/or transceiver 1201. For example, intent handler 1209 may determine and propagate a network capability/capabilities; and processing circuitry 1203 may control transceiver 1201 to transmit downlink communications through transceiver 1201 over a radio interface to one or more communication devices and/or to receive uplink communications through transceiver 1201 from one or more communication devices over a radio interface. Similarly, processing circuitry 1203 may control network interface 1207 to transmit communications through network interface 1207 to one or more other network nodes and/or to receive communications through network interface from one or more other network nodes. Moreover, modules may be stored in memory 1205, and these modules may provide instructions so that when instructions of a module are executed by intent handler 1209 and/or processing circuitry 1203, intent handler 1209 and/or processing circuitry 1203 performs respective operations (e.g., operations discussed below with respect to Example Embodiments relating to network nodes). According to some embodiments, network node 1200 and/or an element(s)/function(s) thereof may be embodied as a virtual node/nodes and/or a virtual machine/machines, and can be implemented as a part of a virtual network function or part of existing network functions, including in a cloud environment.

According to some other embodiments, a network node may be implemented as a network node without a transceiver. In such embodiments, transmission to a wireless communication device may be initiated by the network node so that transmission to the wireless communication device is provided through a network node including a transceiver (e.g., through a base station or RAN node). According to embodiments where the network node is a RAN node including a transceiver, initiating transmission may include transmitting through the transceiver.

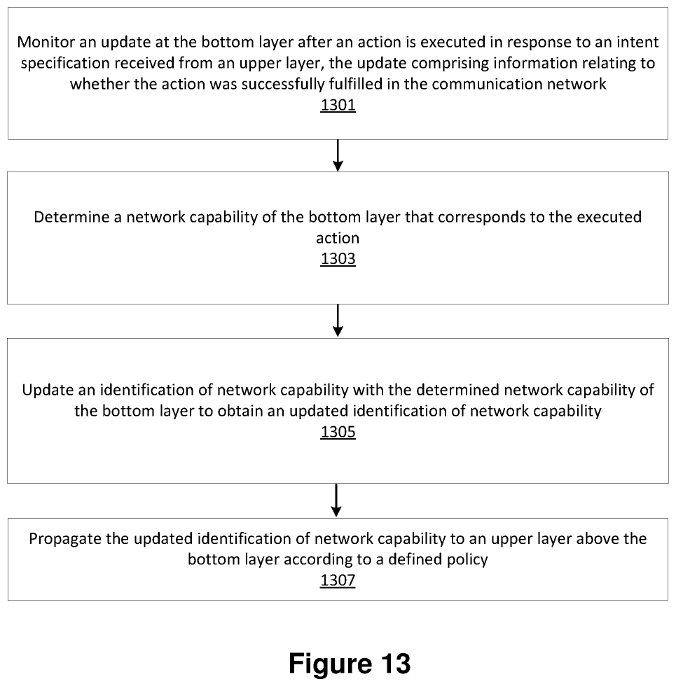

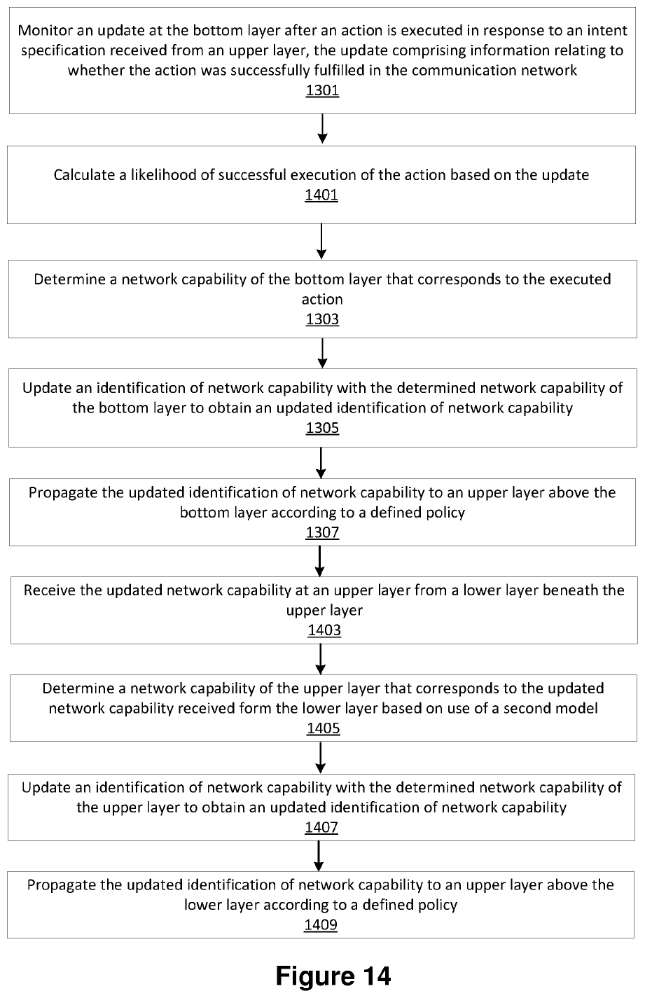

In the description that follows, while the network node may be any of the network node 1200, network node QQ110A, QQ110B, QQ300, QQ606, hardware QQ504, or virtual machine QQ508A, QQ508B, the network node 1200 shall be used to describe the functionality of the operations of the network node. Operations of the network node 1200 (implemented using the structure of FIG. 12) will now be discussed with reference to the flow charts of FIGS. 13-14 according to some embodiments of inventive concepts. For example, modules may be stored in memory 1205 of FIG. 12, and these modules may provide instructions so that when the instructions of a module are executed by respective network node intent handler 1209 and/or processing circuitry 1203, intent handler 1209 and/or processing circuitry 1203 performs respective operations of the flow charts.

Referring first to FIG. 13, a method for communicating information among a hierarchy of management systems (200) structured as a plurality of layers including upper layers and a bottom layer for managing a communication network is provided. The method includes monitoring (1301) an update at the bottom layer after an action is executed in response to an intent specification received from an upper layer. The update includes information relating to whether the action was successfully fulfilled in the communication network. The method further includes determining (1303) a network capability of the bottom layer that corresponds to the executed action. The method further includes updating (1305) an identification of network capability with the determined network capability of the bottom layer to obtain an updated identification of network capability. The method further includes propagating (1307) the updated identification of network capability to an upper layer above the bottom layer according to a defined policy.

In some embodiments, the determining (1303) is performed with a first model. The first model includes at least one of a machine learning model, a policy, and a set of rules that maps the executed action to the determined network capability of the bottom layer.

Referring to FIG. 14, in some embodiments, the method further includes receiving (1403) the updated network capability at an upper layer from a lower layer beneath the upper layer. The method further includes determining (1405) a network capability of the upper layer that corresponds to the updated network capability received from the lower layer based on use of a second model. The method further includes updating (1407) an identification of network capability with the determined network capability of the upper layer to obtain an updated identification of network capability. The method further includes propagating (1409) the updated identification of network capability to another upper layer above the upper layer according to a defined policy.

In some embodiments, the second model includes at least one of a machine learning model, a policy, and a set of rules and the use of the second model comprises mapping the updated network capability received from the lower layer to the determined network capability output from the upper layer.

In some embodiments, the network capability corresponds to at least one of a resource, a service, and a performance of a service that a layer from the plurality of layers can deliver based on the determination from the first model or the second model to fulfill a request received at the network node from a communication device for an intent specification.

In some embodiments, the intent specification includes an identification of at least one of a goal, a requirement, and a constraint that the communication device expects to be fulfilled in the communication network.

In some embodiments, the information includes an indication of at least one of the action was successfully fulfilled, the action was not successfully fulfilled, and a measurement of a degree of a fulfillment of the action.

In some embodiments, the bottom layer includes an identification of the network capabilities of a plurality of entities in the communication network that are managed by the bottom layer.

In some embodiments, the action includes an application interface call towards an entity in the communication network that is managed by the bottom layer.

Referring again to FIG. 14, in some embodiments, the information is a measurement of a degree of a fulfillment of the action, and the method further includes calculating (1401) a likelihood of successful execution of the action based on the update; and when the likelihood of successful execution is greater than a defined threshold, performing the determining (1303).

In some embodiments, the action is a hypothetical action, the communication network is a simulated or sandboxed communication network, and the hypothetical action is received by the simulated or sandboxed communication network.

Various operations from the flow chart of FIG. 14 may be optional with respect to some embodiments of network nodes and related methods. For example, operations of blocks 1401-1409 of FIG. 14 may be optional.

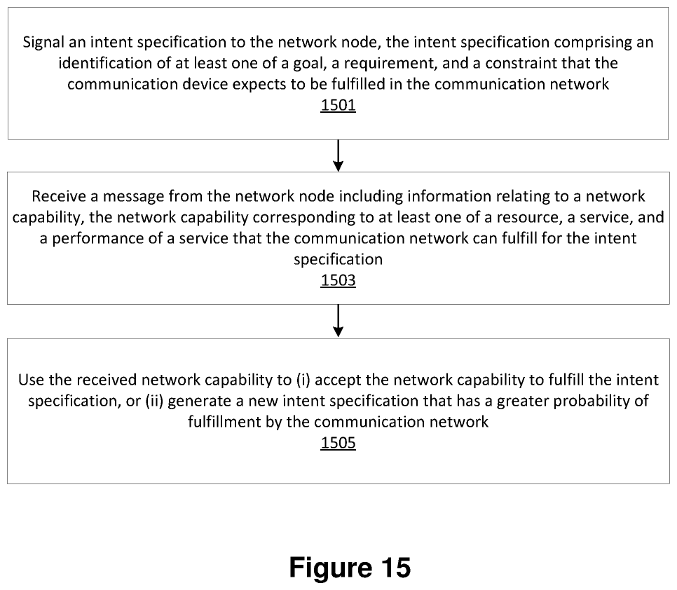

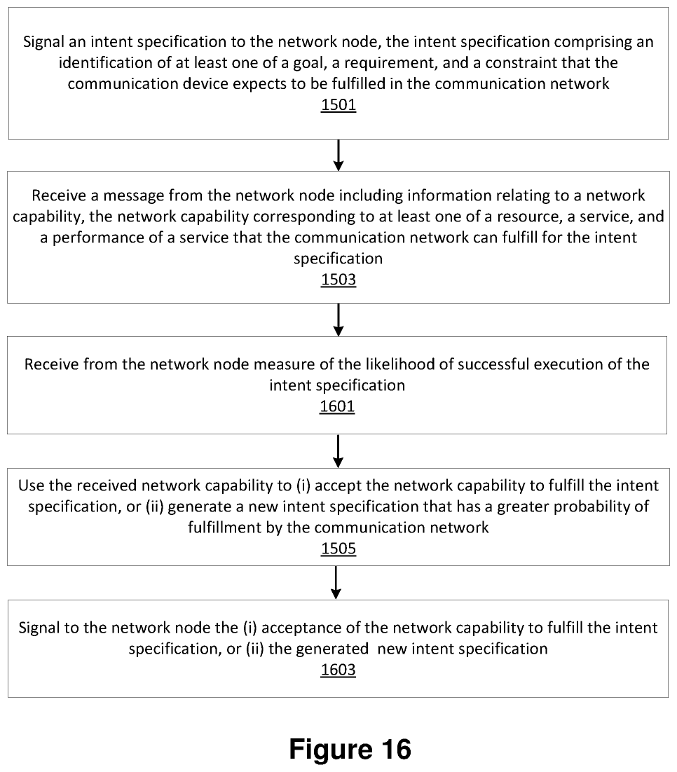

In the description that follows, while the communication device may be any of the communication device 1100, 201, wireless device QQ112A, QQ112B, wired or wireless devices UE QQ112C, UE QQ112D, UE QQ200, virtualization hardware QQ504, or virtual machines QQ508A, QQ508B, the communication device 1100 shall be used to describe the functionality of the operations of the communication device. Operations of the communication device 1100 (implemented using the structure of the block diagram of FIG. 11) will now be discussed with reference to the flow charts of FIGS. 15 and 16 according to some embodiments of inventive concepts. For example, modules may be stored in memory 1105 of FIG. 11, and these modules may provide instructions so that when the instructions of a module are executed by respective communication device processing circuitry 1103, processing circuitry 1103 performs respective operations of the flow charts.

Referring to FIG. 15, a method performed by a communication device (1100) in a communication network for managing an intent specification to a network node is provided. The method includes signalling (1501) an intent specification to the network node. The intent specification includes an identification of at least one of a goal, a requirement, and a constraint that the communication device expects to be fulfilled in the communication network. The method further includes receiving (1503) a message from the network node including information relating to a network capability. The network capability corresponding to at least one of a resource, a service, and a performance of a service that the communication network can fulfill for the intent specification. The method further includes using (1505) the received network capability to (i) accept the network capability to fulfill the intent specification, or (ii) generate a new intent specification that has a greater probability of fulfillment by the communication network.

Referring to FIG. 16, in some embodiments, the method further includes signalling (1603) to the network node the (i) acceptance of the network capability to fulfill the intent specification, or (ii) the generated new intent specification.

In some embodiments, the received network capability is determined by a model of a layer of the hierarchy of management systems.

In some embodiments, the model includes at least one of a machine learning model, a policy, and a set of rules; and the use of the model includes mapping a network capability received from a layer of the hierarchy of management systems to the determined network capability output from the layer to the communication device.

In some embodiments, the information includes an indication of at least one of the intent specification was successfully fulfilled, the intent specification was not successfully fulfilled, and a measurement of a degree of a fulfillment of the intent specification.

Referring again to FIG. 16, in some embodiments, the information is a measurement of a degree of the fulfillment of the intent specification, the method further includes receiving (1601) from the network node measure of the likelihood of successful execution of the intent specification.

Various operations from the flow chart of FIG. 16 may be optional with respect to some embodiments of communication devices and related methods. For example, operations of blocks 1601 and 1603 of FIG. 16 may be optional.

FIG. 17 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 17 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b).

FIG. 18 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 18. The level of integration between the components may vary from one UE to another UE. Further, certain UEs may contain multiple instances of a component, such as multiple processors, memories, transceivers, transmitters, receivers, etc.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

FIG. 19 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

Embodiments of the network node QQ300 may include additional components beyond those shown in FIG. 19 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

FIG. 20 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

Although the communication devices and network nodes described herein may include the illustrated combination of hardware components, other embodiments may comprise computing devices with different combinations of components. It is to be understood that these communication devices and network nodes may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, communication devices and network nodes may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A method performed by a network node for communicating information among a hierarchy of management systems structured as a plurality of layers including upper layers and a bottom layer for managing a communication network, the method comprising:
monitoring an update at the bottom layer after an action is executed in response to an intent specification received from an upper layer, the update comprising information relating to whether the action was successfully fulfilled in the communication network;
determining a network capability of the bottom layer that corresponds to the executed action;
updating an identification of network capability with the determined network capability of the bottom layer to obtain an updated identification of network capability; and
propagating the updated identification of network capability to an upper layer above the bottom layer according to a defined policy.

2. The method of claim 1, wherein the determining is performed with a first model, the first model comprising at least one of a machine learning model, a policy, and a set of rules that maps the executed action to the determined network capability of the bottom layer.

3. The method of claim 1, further comprising:
receiving the updated network capability at an upper layer from a lower layer beneath the upper layer;
determining a network capability of the upper layer that corresponds to the updated network capability received from the lower layer based on use of a second model;
updating an identification of network capability with the determined network capability of the upper layer to obtain an updated identification of network capability; and
propagating the updated identification of network capability to another upper layer above the upper layer according to a defined policy.

4. The method of claim 3, wherein the second model comprises at least one of a machine learning model, a policy, and a set of rules and the use of the second model comprises mapping the updated network capability received from the lower layer to the determined network capability output from the upper layer.

5. The method of claim 1, wherein the network capability corresponds to at least one of a resource, a service, and a performance of a service that a layer from the plurality of layers can deliver based on the determination from the first model or the second model to fulfill a request received at the network node from a communication device for an intent specification.

6. The method of claim 5, wherein the intent specification comprises an identification of at least one of a goal, a requirement, and a constraint that the communication device expects to be fulfilled in the communication network.

7. The method of claim 1, wherein the information comprises an indication of at least one of the action was successfully fulfilled, the action was not successfully fulfilled, and a measurement of a degree of a fulfillment of the action.

8. The method of claim 1, wherein the bottom layer comprises an identification of the network capabilities of a plurality of entities in the communication network that are managed by the bottom layer.

9. The method of claim 1, wherein the action comprises an application interface call towards an entity in the communication network that is managed by the bottom layer.

10. The method of claim 1, wherein the information is a measurement of a degree of a fulfillment of the action, the method further comprising:
calculating a likelihood of successful execution of the action based on the update; and
when the likelihood of successful execution is greater than a defined threshold, performing the determining.

11. The method of claim 1, wherein the action is a hypothetical action, wherein the communication network is a simulated or sandboxed communication network, and wherein the hypothetical action is received by the simulated or sandboxed communication network.

12. A network node for communicating information among a hierarchy of management systems structured as a plurality of layers including upper layers and a bottom layer for managing a communication network, the network node comprising:
at least one processor;
at least one memory connected to the at least one processor and storing program code that is executed by the at least one processor to perform operations comprising:
monitor an update at the bottom layer after an action is executed in response to an intent specification received from an upper layer, the update comprising information relating to whether the action was successfully fulfilled in the communication network;
determine a network capability of the bottom layer that corresponds to the executed action;
update an identification of network capability with the determined network capability of the bottom layer to obtain an updated identification of network capability; and
propagate the updated identification of network capability to an upper layer above the bottom layer according to a defined policy.

13. The network node of claim 12, the at least one memory connected to the at least one processor and storing program code that is executed by the at least one processor to perform operations wherein the determining is performed with a first model, the first model comprising at least one of a machine learning model, a policy, and a set of rules that maps the executed action to the determined network capability of the bottom layer.

14-19. (canceled)

20. A method performed by a communication device in a communication network for managing an intent specification to a network node, the method comprising:
signalling an intent specification to the network node, the intent specification comprising an identification of at least one of a goal, a requirement, and a constraint that the communication device expects to be fulfilled in the communication network;
receiving a message from the network node including information relating to a network capability, the network capability corresponding to at least one of a resource, a service, and a performance of a service that the communication network can fulfill for the intent specification; and
using the received network capability to (i) accept the network capability to fulfill the intent specification, or (ii) generate a new intent specification that has a greater probability of fulfillment by the communication network.

21. The method of claim 20, further comprising:
signalling to the network node the (i) acceptance of the network capability to fulfill the intent specification, or (ii) the generated new intent specification.

22. The method of claim 20, wherein the received network capability is determined by a model of a layer of the hierarchy of management systems.

23. The method of claim 20, wherein the model comprises at least one of a machine learning model, a policy, and a set of rules, and wherein the use of the model comprises mapping a network capability received from a layer of the hierarchy of management systems to the determined network capability output from the layer to the communication device.

24. The method of claim 20, wherein the information comprises an indication of at least one of the intent specification was successfully fulfilled, the intent specification was not successfully fulfilled, and a measurement of a degree of a fulfillment of the intent specification.

25. The method of claim 24, wherein the information is a measurement of a degree of the fulfillment of the intent specification, the method further comprising:
receiving from the network node measure of the likelihood of successful execution of the intent specification.

26. A communication device in a communication network for managing an intent specification to a network node, the communication device comprising:
at least one processor;
at least one memory connected to the at least one processor and storing program code that is executed by the at least one processor to perform operations comprising:
signal an intent specification to the network node, the intent specification comprising an identification of at least one of a goal, a requirement, and a constraint that the communication device expects to be fulfilled in the communication network;
receive a message from the network node including information relating to a network capability, the network capability corresponding to at least one of a resource, a service, and a performance of a service that the communication network can fulfill for the intent specification; and
use the received network capability to (i) accept the network capability to fulfill the intent specification, or (ii) generate a new intent specification that has a greater probability of fulfillment by the communication network.

27-33. (canceled)
